(19) United States
(12) Patent Application Publication
(10) Pub. No.: US 2008/0021885 A1
(43) Pub. Date: Jan. 24, 2008

(54) SYSTEM FOR SUBSTANTIALLY IMMEDIATE PAYMENT FOR SEARCH RELATED TASKS

(75) Inventor: Scott A. Jones, Carmel, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc., Carmel, IN (US)

(21) Appl. No.: 11/782,275

(22) Filed: Jul. 24, 2007

Related U.S. Application Data
(60) Provisional application No. 60/820,179, filed on Jul. 24, 2006.

(51) Int. Cl. G06F 17/30

(52) U.S. Cl. 707/3

(57) ABSTRACT

The embodiments discussed herein provide a search system where a searcher can perform searches and earn income in the form of cash or non-cash compensation based on completed searches or other search related tasks and an associated payment system, such as a bank, where the searcher can be substantially immediately paid the earned income. As the searcher completes searches, income is posted to an account of the searcher in the search system. Upon request by the searcher, using a graphical user interface where a payment amount can be specified, the earned income corresponding to the payment amount is substantially immediately transferred from a search system account in the payment system to a searcher's account in the payment system via an account credit request sent by the search system to the payment system. The searcher's account in the search system is debited for the amount of the payment. At the payment system, the searcher can use earned income for purchases, such as by making purchase with a debit card or withdrawing cash with the debit card at an ATM.

### CROSS-REFERENCE TO RELATED APPLICATION(S)

This application is related to and claims priority to U.S. Provisional Application entitled, “A System For Immediate Payment For Piecework”, having Ser. No. 60/820,179, by Scott A. Jones, filed Jul. 24, 2006, is related to U.S. application Ser. No. 11/336,928, entitled, “A Scalable Search System Using Human Searchers”, inventor Scott A. Jones, filed Jan. 23, 2006, is related to U.S. Application entitled, “Method And System Tracking Work Done By Human Workers”, having Ser. No. 60/807,683, by Scott A. Jones et al., filed Jan. 11, 2007 and is related to U.S. Provisional Application entitled, “Method, System And Computer Program For Multilevel Marketing”, having Ser. No. 60/821,647, Attorney Docket 1918.1013, by Scott A. Jones, filed Aug. 7, 2006 all of which are incorporated by reference herein.

### BACKGROUND

1. Field

The embodiments discussed herein are directed to a system that allows a worker to perform a search or other network-based task and receive immediate payment for the task.

2. Description of the Related Art

Workers in the information processing industry often perform computer-based tasks or micro tasks. Such tasks may involve performing a search for information based on a user query, photograph recognition (as per Amazon® Mechanical Turk) or sorting, speech-to-text transcription, text-to-speech conversion, fielding a request for information about an account, such as answering a credit card holder's questions about the status of their account, or performing a bank back office international trade transaction. These types of tasks may be called electronic piecework tasks and the workers may be paid on a piecework basis, that is, paid based on the task(s) completed. It is often typical for such workers to be paid on a periodic basis, such as every two weeks, via check or an electronic deposit into their checking account.

Some of theses workers may desire to be paid immediately upon the completion of each task or when the worker requests to be paid. For example, a young person who has performed a number of electronic piecework tasks and who is out on a date may want to go to a movie and realize that he or she does not have the cash to pay for the movie and that their checking account also has a balance that is too low. The young person may desire to be immediately paid for the piecework and have immediate access to his or her accumulated earnings so that he or she can go to the movie.

Such workers may have a desire to obtain enough money to accomplish a desired purchase and may work until they have earned the desired amount, such as the person recognizing that they want to go to a movie that night but realizing that he or she does not have enough money and thus doing piecework that day to earn the money. In some cases a worker may wish to be paid in cash when a specific condition is reached, such as a milestone completion in a task, or when accumulated funds have met a specific threshold in order to reduce transaction costs as a percentage of earnings, and/or to manage funds more effectively (e.g., make a payment on the date due in order to avoid late fees, but accrue maximum interest on the funds or transfer funds to one or more accounts immediately upon completion of a task in order to maximize cash utilization).

Other types of workers who do not perform such piecework tasks also may desire immediate payment for work that they have done.

What is needed is a system that will effect such an immediate payment for an activity.

### SUMMARY

It is an aspect of the embodiments discussed herein to provide a system that allows a worker to be immediately paid for a task(s) performed by the worker as the task(s) are completed and/or other conditions are met.

It is another aspect of the embodiments discussed herein to provide a system that credits a worker or searcher for search results as they are completed.

It is another aspect of the embodiments discussed herein to provide a system to allow a worker to draw on earned but not paid income using an electronic card, such as a debit card.

The embodiments discussed herein provide a search system where a searcher can perform searches and earn income based on completed searches and a payment system where the searcher can be substantially immediately paid the earned income. As a searcher (or worker) completes searches (or tasks), income is posted to an account of the searcher in the search system. Upon request by a searcher, earned income can be transferred from a search system account to a searcher's payment system account where the searcher can use the money for purchases, such as making a purchase with an electronic card. A request may be made explicitly or according to a pre-established set of conditions.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts a system according to the embodiments discussed herein.

FIG. 2 depicts a transfer process.

FIG. 3 illustrates a request for transfer process.

FIG. 4 depicts a database.

FIGS. 5-7 show graphical user interfaces.

FIG. 8 depicts a process.

FIG. 9 shows a graphical user interface.

### DETAILED DESCRIPTION OF THE PREFERRED EMBODIMENTS

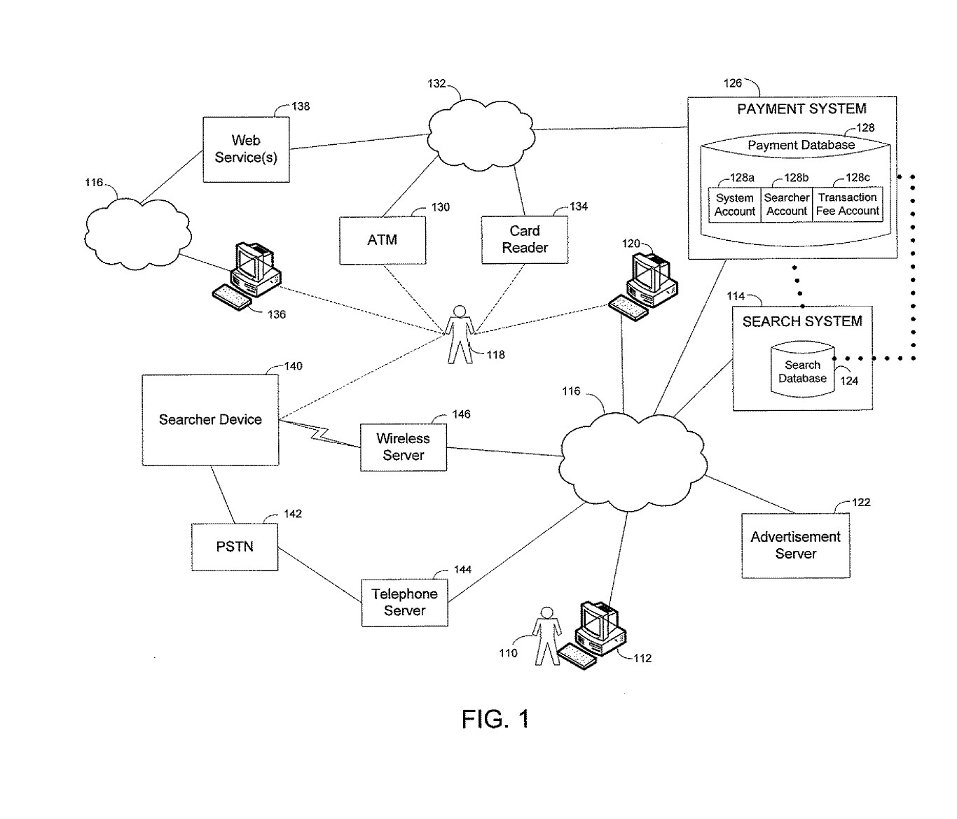

In a typical guide-based search, a person seeking information 110 (FIG. 1) using a user computer system 112 (or a PDA-type device, or other device capable of sending a query) sends a query to a search system 114, such as described in U.S. application Ser. No. 11/336,928, entitled, “A Scalable Search System Using Human Searchers”, inventor Scott A. Jones, filed Jan. 23, 2006, the disclosure of which is incorporated herein by reference, over a communication network 116, such as the Internet. The search system 114 assigns the query or search task to a guide(s) or searcher(s) 118 and transmits the query to the searcher computer system 120. The searcher 118 uses the searcher computer system 120 to obtain information relevant to the query by performing a search(es) utilizing a search engine(s), such as Yahoo!®, and/or searches of other resources such as information complied by the searcher 118 and/or services such as WebMD® (for medical information) or ESPN® (for sports information). While a search is being performed, the information seeker 110 may be provided advertisement(s) or other information which may be relevant to a query from an advertisement server 122. When a search is completed, a searcher may send search results to the user (or Infoseeker™) computer 112 (FIG. 1). The search system 114 can be paid for search(es), for advertisement(s) or for other information presented to, used by and/or purchased by an information seeker(s).

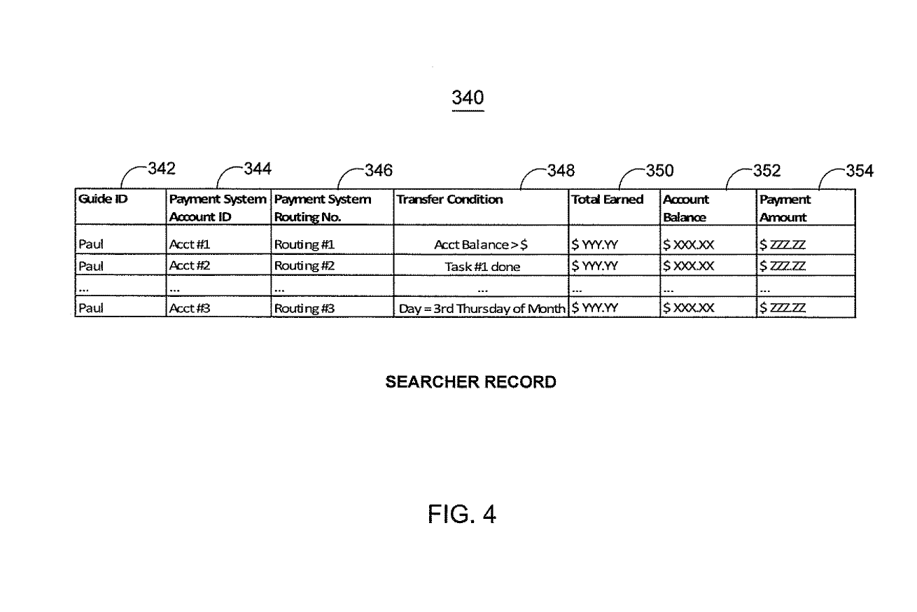

When a search is completed, the search system 114 can credit a searcher search system account (see FIG. 4) in the search database 124 (FIG. 1) with a credit (or payment) for the completion of a search/task using some payment method/formula. For example, a searcher account may be credited at a rate of $5.00 per hour for each completed search. Alternatively, a searcher might be paid at a rate of $0.10 per search or via some other equation for compensation. A searcher may receive a royalty type payment when materials which he or she has created are accessed by information seekers. Searchers may also be paid for training a searcher(s) and/or for reviewing and/or rating a searcher(s) and/or work(s) produced by them. An entity registered with the search system which has recruited may also earn credit for work(s) done by sponsored worker(s). Typically, at periodic intervals, such as two weeks, the search system 114 by default may issue a batch process paycheck to the searcher 118, as is a well-known technique for compensating workers who work online or offline. For search activity or for other search related activity(ies) such as training a searcher(s), review of search result(s), recruitment of a searcher(s), or other activities, a worker and/or an entity may accrue earnings. At the end of a work period, a worker and/or entity can be paid for work.

Rather than wait for a paycheck, the searcher 118 can request substantially immediate payment from the searcher's account in the search system 114. By substantially immediate payment what is meant is payment (or availability of funds and/or goods and/or services) faster than a paycheck or a wire transfer, typically on the order of less than 15 minutes, often less than 15 seconds, and preferably less than one second, or “on demand”. To make an immediate payment request, the searcher 118 can send a request for such payment to the search system 114 from the computer system 120. The search system 114, in response to an immediate payment request, debits a searcher's account in the search database 124 by the amount of the immediate payment request (and any service charge(s) by the systems 114 and 126) and sends a transfer request to a payment system 126, such as PayPal® of San Jose, Calif. or via a bank such as First Internet Bank of Indianapolis, Ind. A transfer request causes the payment system 126 to transfer the payment amount from a search system account 128a in the payment system database 128 to a searcher account 128b in the payment system database 128 (FIG. 1). If this transfer is completed, the searcher 118 may have access to the amount via a number of different access systems as discussed below. It is important to note that an immediate payment request may be generated by overt actions, such as a key press in a graphical user interface (GUI), or a verbal request via a cell phone, or may be generated by implicit actions, such as an overdraft condition in a payment account, completion of work(s) by worker(s) of which the searcher may be unaware, or achievement of any pre-established condition(s). Like wise payment may be effected to more than one payment system account, dependent upon a condition(s).

At the time of the payment request, a searcher/entity account in the search system 114 may include a single payment as noted above or may include accumulated payments from numerous searches or activities. A payment request made by a searcher can include all of the money in the searcher's account or some fraction thereof as will be discussed later herein. Prior to a payment request, a searcher must have established an account with the payment system 126 (although at the time of a request a dialog can be established with a searcher to create an account, or to designate an existing account) and, as will be discussed later herein, preferably has also obtained an electronic transfer card for the payment system, such as a debit card or a credit card. A searcher or entity may also need to include or store relevant information regarding the searcher account 128b in the payment system 126 in the configuration information or profile of the searcher in the search system 114.

A searcher can also set a configuration preference in the search system 114 to automatically make a request for payment if a condition or event occurs. That is, a searcher need not make an explicit request for payment, it can be automatic. This may be accomplished per task, per hour, per day, by reaching a threshold related to the value of work completed, calendar time, amount of work completed (such as number of searches), etc. and/or any combination thereof. Any condition defined by a searcher or system administrator(s) may trigger an immediate payment. An immediate payment may be directed to any of a searcher's payment system accounts as designated by the searcher. An event may also cause a payment to be made to a designated searcher payment account, as described further below.

Using a debit/credit card issued to the searcher 118 by the payment system 126, the searcher can obtain cash from an automated teller machine (ATM) 130 through a financial network 132 over which the searcher's account in the payment system database 128 is debited. The card and/or other payment device can also be used in a typical purchase transaction, such as at a clothing store or a movie theater, where the card is read or scanned by a card reader 134 (FIG. 1) and acts as a debit or credit card accessing the searcher account in the payment system database 128. A searcher 118 can also use the computer system 120 or the computer system 136, wireless or otherwise, to access a web service(s) 138, such as Amazon®, where a purchase can be made using data associated with the searcher account(s) in the payment system 126. The computer systems 120, 136 may also be used by a searcher to transfer a desired amount (e.g., a gift amount, a share of proceeds from a task, a commission or royalty associated with a work) to other account(s) in the payment system 126 or any payment system(s) which have been associated with the searcher(s) account via an electronic payment/transfer. In countries where other types of electronic devices, such as a telephone, a wireless device, or other means may be used to effect payment, a searcher can use a searcher device 140 (such as a personal digital assistant (PDA), cellular phone, or other device) to make a payment for goods or services, such as a soft drink purchase from a vending machine. In each of these accesses to the payment system 126, conventional financial network operations occur where, for example, the ATM 130 may confirm that the account of a debit card has sufficient funds for a cash withdrawal, cause the account in the payment system 126 to be debited by the cash disbursal requested and any other transaction charges for the disbursal and disburse the funds through the ATM 130 to the card holder. That is, conventional technology can handle requests for debit/credit card transactions or other requests for disbursal of funds from an account in the payment system 126.

Rather than use the computer system 120 to make a request for immediate payment, the searcher 118 can send the immediate payment request to the search system 114 from a device 140 (telephone, PDA, etc.) over the public switched telephone network 142 and a telephone server 144 in the case of a cellular telephone or via a wireless server 146 in the case of a wireless device, or directly over the network 116. This allows the immediate payment system user or searcher 118 in the current example, to obtain access to the funds in the searcher's account in the search system 114 on “a moments notice”. Other devices, such as a wireless capable laptop, a tablet computer, or a telephone (using e.g., voice xML menus) can also be used to make a payment request. Such a request may involve a transaction fee (or fees) from one or more of the service providers, the communications providers, and/or the bank.

As depicted by the dot lines of FIG. 1, the search system 114 may communicate directly to the payment system 126 rather than by a secure link over the communication network 116 and/or the payment system 126 may have direct access to the search database 124.

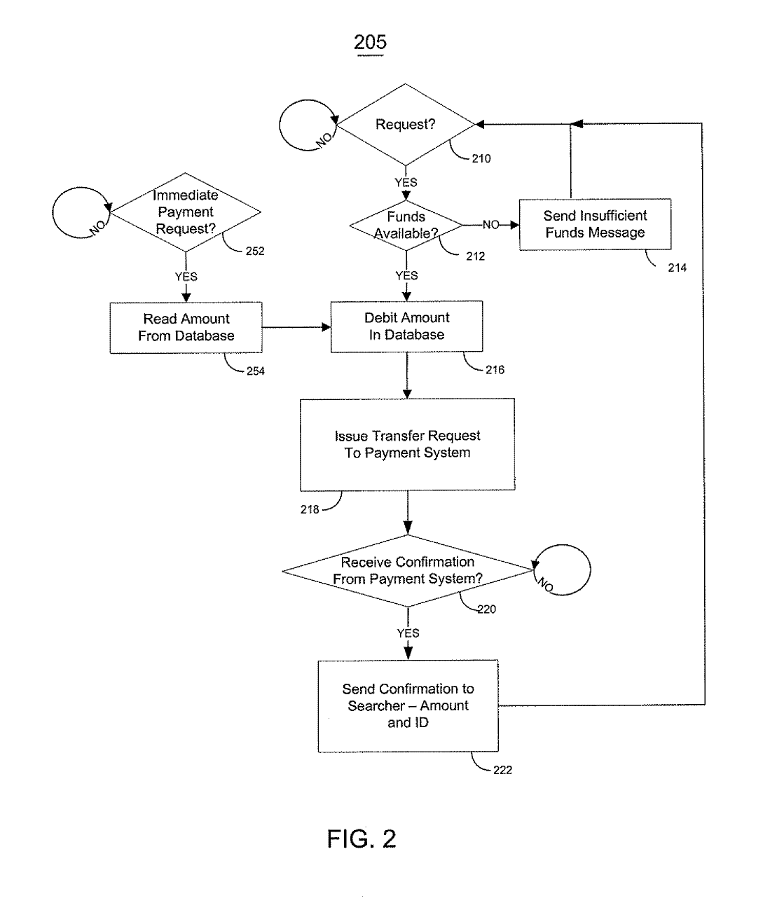

As depicted in FIG. 2, the process 205 of the search system 114 (FIG. 1) for handling a request for payment may wait 210 for a payment request to be received from a request source, such as the computer system 120 (FIG. 1) or the searcher device 140. A request may identify a searcher, searcher account, etc., may include a password, etc. and identifies an amount that is to be substantially immediately paid. If a request is not received, process 205 continues to wait 210 for a payment request to be received. The request is validated and the amount of the request is checked 212 (FIG. 2) against the searcher account in the search database 124 (FIG. 1). If the amount of a request is greater than an amount in a searcher account(s) in the search database 124, an insufficient funds message can be sent 214 (FIG. 2) by the search system 114 (FIG. 1) to the searcher 118 at computer system 120 or the searcher device 140 (for example). Process 205 then continues to wait 210 for a payment request to be received. If sufficient funds are available, the search system 114 debits 216 (FIG. 2) the amount of the request from the searcher's account in the search database 124 (FIG. 1). The search system 114 then issues 218 (FIG. 2) a transfer request to the payment system 126 via an application-programming interface (API) to the payment system or other communication mechanism to transfer the amount of the substantially immediate payment request from the system account 128a (FIG. 1) in the payment system database 128 to the searcher account 128b in the payment system database 128. The transfer request identifies the amount, a system account 128a in the payment system database 128 and a searcher account(s) 128b in the payment system database 128. Optionally, the systems 114 and 126 may charge a transaction fee, either a flat fee (such as $0.50) and/or a percentage (such as 3.0%) for processing a request, any transaction fee(s) could be subtracted from the transfer amount request and credited to the transaction fee account 128c (FIG. 1) of the search system 114 (and/or payment system), and the actual transfer within the payment system 126 would be the request amount less the transaction fee. The search system 114 then waits to receive 220 (FIG. 2) confirmation of the transfer from the payment system 126 (FIG. 1). If confirmation is not received after a defined time period, the search system may cancel the transaction, retry, or otherwise resolve the incomplete transaction with the payment system.

While the search system 114 (FIG. 1) is checking a request, requesting the transfer and/or awaiting confirmation of the transfer, the search system 114 can send a searcher device, such as searcher devices 120, 140 an advertisement(s), such as for a music store, to be presented to the searcher in a suitable manner, obtained from the advertisement server 122 (FIG. 1). The search system 114 may also send a discount offer for goods and/or services to a searcher requesting immediate payment before and/or after the immediate payment request is made.

If confirmation is received from payment system 126, the search system 114 may send 222 (FIG. 2) a confirmation to the searcher 118 (FIG. 1) at the source of a request, which may be computer system 120 (FIG. 1) or searcher device 140, and return to wait 210 (FIG. 2) for a request. A confirmation confirms the amount that has been transferred and also, as desired, confirms the searcher account information used for the transfer, and/or associated information. The payment system 126 (FIG. 1) may also confirm a transaction to a searcher in a manner typically used by a payment system.

If a transfer operation requires a transaction fee, the search system 114 could inform a searcher of the amount of the transaction fee when a request is made by the searcher and received by the system where the information would indicate that the actual amount substantially immediately paid would be the request amount less the transaction fee and may request approval from a searcher of a revised payment amount prior to the check 212 (FIG. 2) of the amount available in the searcher's account.

Rather than debit a system account 128a (FIG. 1) for an amount of a transfer request (plus fees as applicable) when a searcher account 128b is credited, the payment system 126 may later bill the search system 114 for the amount of a credit added to the searcher account 128b plus any fees as a result of a transfer request.

As previously discussed, a searcher can configure the search system 114 to make a substantially immediate payment when a task has been completed, or when any other defined condition(s) is met. In such a situation, the search system 114 (FIG. 1) waits 252 (FIG. 2) for a condition to be met and for a searcher's account in the search database 124 (FIG. 1) to be updated (e.g., a search related task is completed, and credit is added to a searcher's search system account). If an immediate payment request condition is met, such as a task being completed, goal being met, etc. the search system 114 reads 254 (FIG. 2) the amount and other information in a search database 124 (FIG. 1) associated with a searcher's account. The amount of the request is then debited 216 from the searcher's account in the search database 124 and the transfer as discussed previously can be performed. If no immediate payment request condition is met, the search system continues to wait 252 for a condition to be met.

For ease of handling, a bank can allocate a special set of debit card numbers for use with an immediate payment system such as described herein. When a searcher or guide maintains an account with a bank, the transfer from the system (master) account to the account of the searcher is typically called an account credit. A transfer request, when a valid transaction is received, will typically take less than one second. The transfer request could typically be an Automated Clearing House (ACH)-type request or ACH file formatted according to the conventional ACH File Exchange Specifications. The transfer request may not use the conventional ACH system and the transfer request may typically be sent to a bank via the bank internet banking connection, which can include the home banking channel or the automated teller machine (ATM) channel. The transport mechanism can be via a virtual private network (VPN). To prevent the abuse of this type of account as a cash management tool a minimum withdrawal transaction amount may be specified, such as $25.00. A fee for processing a request for immediate payment may be set comparable to an out-of-network ATM fee, such as $2.00.

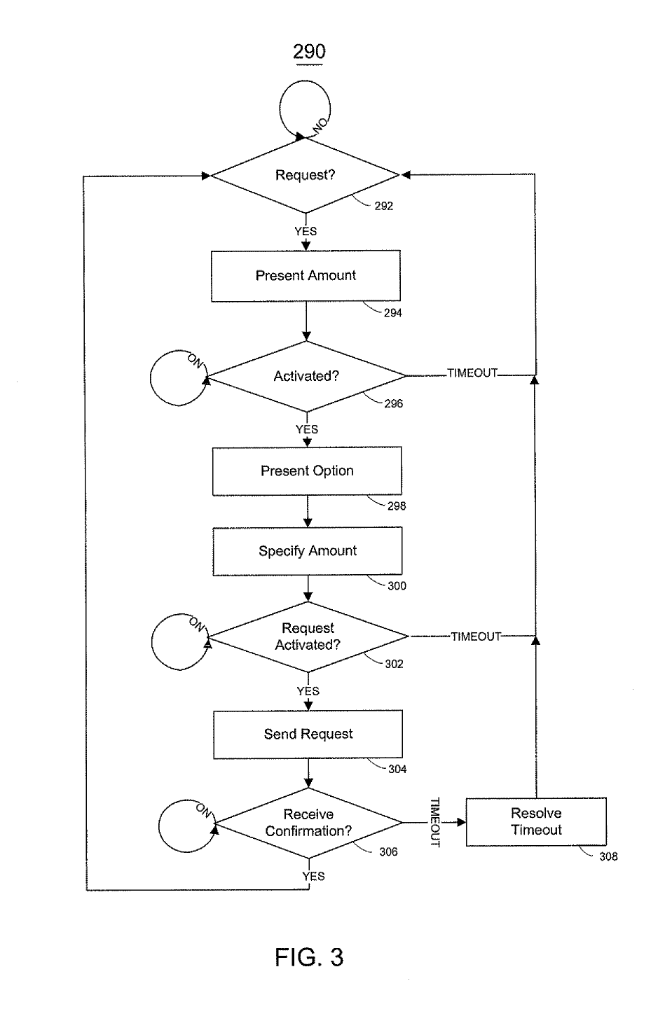

An immediate payment request process 290 (see FIG. 3) may run on a source device, such as the searcher computer system 120 (FIG. 1), searcher device 140, the search system 114, or any other suitable device which may transmit an immediate payment request to the search system 114. The process 290 (FIG. 3) begins with a request 292 for information which may include an amount in a searcher account in the search system 114 (FIG. 1). A request may include a searcher identifier in the search system 114 allowing the system to identify the account of the searcher 118, a password validating the searcher's right to access the search database 124, a command requesting an amount of money in the searcher account in the search database 124 security related data, an identifier (such as a “cookie”) identifying a searcher source device (e.g., the computer system 120 or searcher device 140). Typically, an account ID, password and/or other validation information as applicable may automatically be provided in a request, however, the searcher 118 may be required to enter this information. The request causes the search system 114 to obtain the earned amount of money in the searcher's account and/or other data in the search database 124 and send it to a searcher device, such as searcher devices 120, 140. If no request for information is received, process 290 continues to wait for a request 292.

The process 290 (FIG. 3) then continues to present 294 the amount received from the search system 114 (FIG. 1) in response to the request using a graphical user interface (GUI), or other suitable method for a searcher device, such as searcher devices 120, 140 for review by the searcher 118.

The process 290 (FIG. 3) then determines 296 whether an immediate payment request has been activated by, for example, a searcher activating an immediate payment (PayMeNow™) button or control on the display GUI, a key press or utterance when a voice interface is presented, or other action by the searcher 118 (FIG. 1). If an immediate payment request is not activated, the process 290 (FIG. 3) waits. If no further action is taken by the user within a specified time interval, process 290 times-out and returns to wait for a request 292 for information of a searcher account. If immediate payment has been activated, the process 290 proceeds to present 298 an option to the searcher to allow the searcher to specify the amount to be paid and/or other information.

The searcher 118 (FIG. 1) may then specify 300 (FIG. 3) a different amount than the amount received from the search system, and/or make any modifications to a request for immediate payment. Process 290 proceeds to determine if a request for immediate payment is activated 302 a request by, for example, activating a control such as “clicking” an “OK” button on a GUI, depressing an “enter” type key on a source device keyboard, verbal acceptance, etc.

If a request for immediate payment is not activated, the process 290 waits. If an immediate payment request is not activated within a specified time period, process 290 times-out and returns to wait for a request for searcher account information 292.

If an immediate payment request is activated process 290 then sends 304 the immediate payment request to search system 114 (FIG. 1), and waits for a confirmation 306 (FIG. 3) of the transfer from the payment system 126 (FIG. 1). If confirmation is received, process 290 (FIG. 3) may present an indication of confirmation to the searcher. The process 290 then returns to wait 292 for another request.

If a confirmation is not received from the payment system, the process 290 waits. If a confirmation is not received from the payment system 126 (FIG. 1) within a specified time period, process 290 (FIG. 3) times-out and resolves the timeout condition 308. The search system may re-transmit the transfer request, cancel the transaction and inform the guide or take any suitable action to resolve the timeout condition. Process 290 then returns to wait for another request 292.

The search database 124 (FIG. 1), in addition to storing search results, etc. associated with the search/task(s) performed by a searcher 118 may also store searcher information, such as a ranking of a searcher, and information associated with a payment for a task and substantially immediate payment discussed herein as depicted in FIG. 4. The search database 124 (FIG. 1) may comprise a searcher record 340 (see FIG. 4) for a searcher(s). While a single searcher record is depicted in FIG. 4, it is envisioned that a separate searcher record may be maintained by the search system 114 for any searcher.

As illustrated in FIG. 4, a searcher record 340 may include a record having a guide ID field 342, a payment system account ID field 344, a payment system routing number field 346, a transfer condition field 348, a total earned field 350, an account balance field 352 and a payment amount field 354.

The guide ID field 342 includes a unique identifier for a guide which is used to differentiate the guide record of a guide from the guide record of other guides.

The payment system account ID field 344 includes a searcher's account information (credit/debit card) in the payment system 126 (FIG. 1). Payment system account information may be used to transmit payment to a payment system account associated with the guide record.

The payment system routing number field 346 (FIG. 4) includes the routing number for a searcher's account within the payment system 126 (FIG. 1). The routing number may be used to transmit payment to a payment system account associated with the guide record.

The transfer condition field 348 (FIG. 4) includes information about the condition(s) for immediate payment after a condition is met as discussed previously for a guide associated with the guide record.

The total earned field 350 includes the total amount earned by a searcher/guide/worker associated with the guide record during a period of time.

The account balance field 352 may include the current amount of money that is available in a search account associated with the guide record.

The payment amount field 354 may include the amount of a request for immediate payment associated with the transfer condition field 348 of a searcher record.

The search database 124 (FIG. 1) may also record other financial information that may be needed according to law, such as a searcher's tax rate, tax withholding amount, social security number, etc. which may affect the amount actually accessible to be transferred to the searcher via, for example, the debit card.

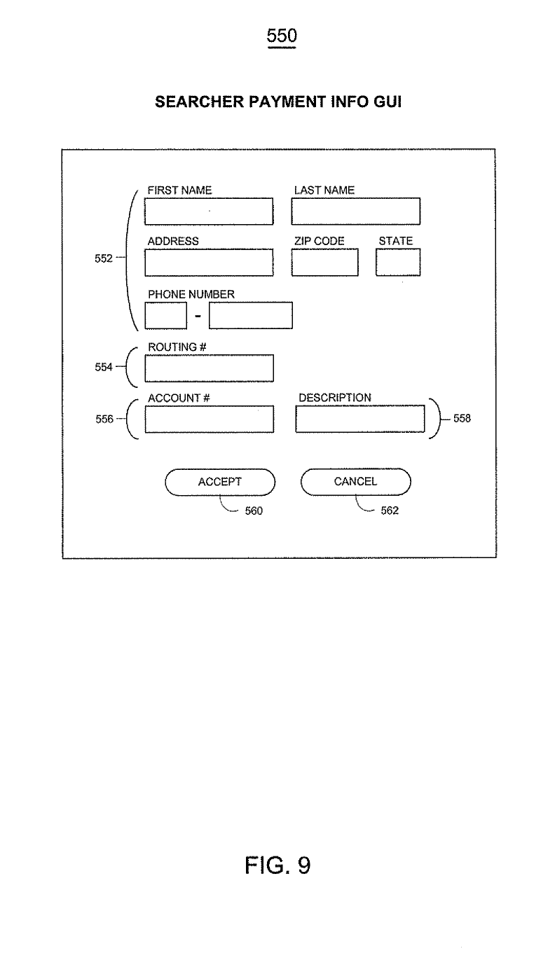

The payment system database 128 contains a master search system account 128a from which payment funds can be transferred to a searcher's account, such as the searcher account 128b, when a payment is requested. Since the system described herein needs a searcher account in the payment system 126, a searcher may be required to establish such an account before making a request for immediate payment or being permitted to set the configuration variables described above to make an immediate payment. In at least one embodiment, this information may be gathered using for example a graphical user interface (GUI) such as GUI 550 (FIG. 9)

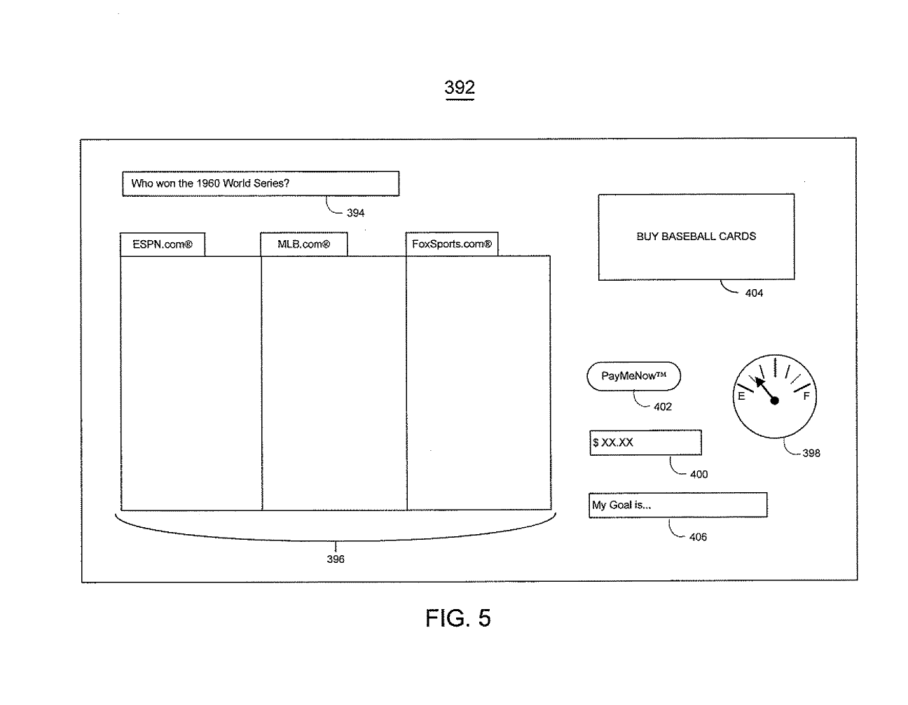

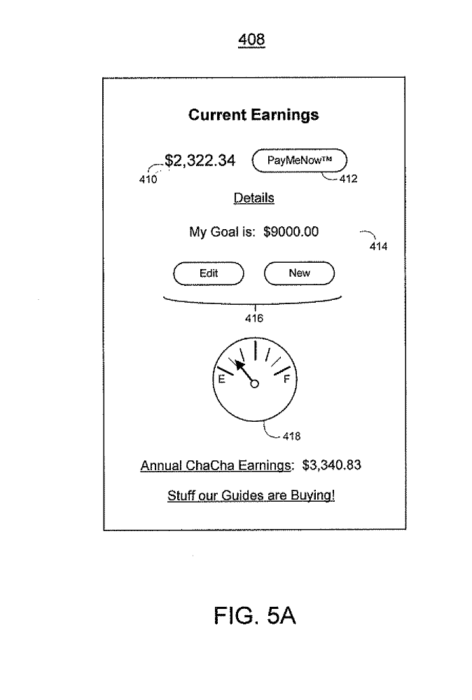

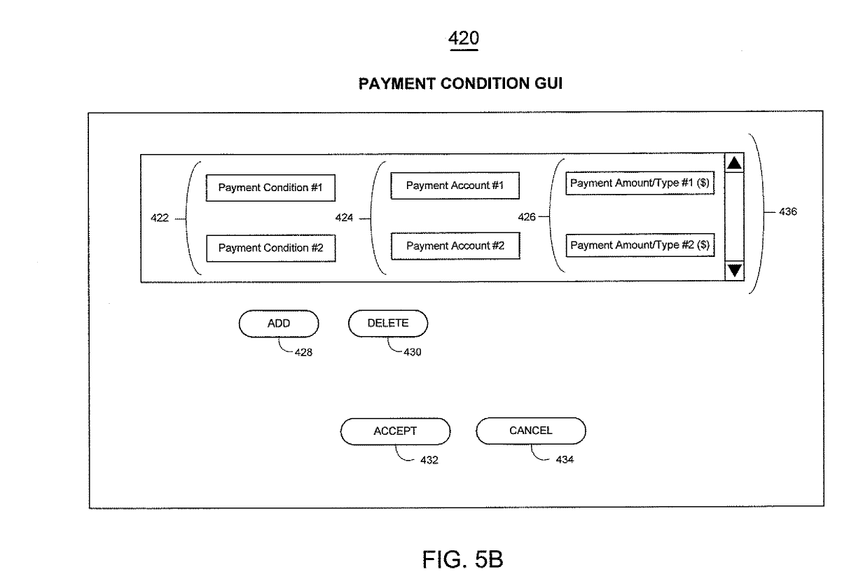

FIG. 5 depicts a GUI 392 displayed on computer system 120 (FIG. 1) for a performing a search task and from which a searcher can request immediate payment (PayMeNow™) in at least one embodiment. This interface 392 (FIG. 5) includes a query field 394 in which a query of a user 110 (FIG. 1) is displayed. A frame 396 (FIG. 5) for organizing results of a search by a searcher 118 (FIG. 1) and from which search results can be selected and transmitted to the user computer 112 may also be provided. An indicator 398 (FIG. 5) of the amount of work that has been accomplished can also be provided. This interface may also include a field 400 that shows the current amount that a searcher has earned by completing one or more search tasks. A button or control 402 can also be included that initiates a request for immediate payment.

The GUI 392 (FIG. 5) may also contain an advertising window 404 and a goal selection box 406. The goal selection box 406 can lead to a GUI such as FIG. 4 of the related application entitled, “Method And System Tracking Work Done By Human Workers”, previously mentioned, or can display the remaining efforts needed to attain a goal as per FIGS. 4A and 4B of the same application. A guide may choose to select a non-cash or cash goal(s). Any or all earnings of the guide may then be interpreted as “points” which could count toward achieving a goal(s) as designated by a guide. If a target has been achieved, a guide may choose to purchase an item immediately and the payment amount would then be debited from his or her earnings account and appropriately credited to an account of a merchant or merchants supplying the goal good and/or service in payment system 128 (FIG. 1). For example, a goal could be a good or service (e.g. a movie ticket, a haircut, etc.), in which case the ticket could be purchased immediately and picked-up at “will call”. This may be advantageous for obtaining discounts from offering merchants, etc. which may improve guide morale.

FIG. 5A is an illustration of how the current earnings and goal GUI 408 could be arranged in at least one embodiment. The GUI 408 shows accumulated “earnings” 410 associated with a button 412 that when activated causes a request for immediate payment to be made, along with a goal 414 that can be edited or replaced with a new goal via associated buttons 416. The GUI 408 may also show an indicator 418 of the amount of work that has been accomplished, and other relevant information.

In the illustration, the goal is currently a cash amount. But if the goal were merchandise, such as a movie ticket, then the display may show a movie ticket and percentage of the total earnings needed to get a ticket. The underlying basis is money, but there could be discounts associated with a ticket purchase that are not readily visible which could make it easier to get the ticket. For example, if a worker could choose a movie ticket as a goal, the undiscounted price of the ticket might be $9.00. If the worker earns $5.00 per search hour as a guide, the worker needs to work for 1.8 hours to get the ticket. But the search system (being a considerable buyer of tickets for its guides) may be able to get the same ticket for $7.00. So, the search system may offer the ticket to guides at, for example, $7.50 of equivalent service(s). In this example, the earnings would only need to correspond to 1.5 hours of guide efforts to obtain the movie ticket for a worker. A worker can then activate the PayMeNow™ button 412 and the ticket in this example would be allocated (bought for the worker) at a movie theater and made available for pick-up at the “will-call” window.

The goal field 414 may be a drop-down menu that would allow the selection of different goals. The system may automatically “pay” a selected goal when the goal is reached. Using the example above, if a worker reaches a goal for the movie ticket, the system would automatically “buy” the ticket electronically and the worker can show up at the movie house and pick-up the ticket. In this way, a “triggered” payment occurs where a payment is made when a pre-determined objective is met, such as for example, “$200 of accrued earnings”, or “2 movie tickets, popcorn and 2 large drinks”.

FIG. 5B depicts a GUI 420 which may be used by a searcher/worker to enter parameters for an automatic immediate payment request. The GUI 420 may include payment condition field(s) 422, payment account field(s) 424, payment amount/type field(s) 426, “add” button 428, “delete” button 430, “accept” button 432, “cancel” button 434, and navigation controls 436.

The payment condition field(s) 422 allows a guide to specify a condition(s) under which a payment request is to be made, such as “date/time equals”, “account balance greater than”, “goal (n) achieved”, “whenever a task is complete”, “Friday every two weeks”, “the fifteenth of every month”, “second Thursday of each month”, etc. This allows a searcher to specify a condition(s) under which an immediate payment request is made. Conditions might be logical combinations. For example, “any task is complete” AND “account balance is greater than $100”, or “when goal (n) is achieved” OR “last day of the month” OR “PayMeNow™ is selected”. The condition field may be implemented as a drop-down menu or other suitable interface.

The payment account field(s) 424 allows a guide to specify a payment system account(s) to which a transfer is to be made when a condition is true. For example, a guide may have multiple accounts with the payment system (savings, checking, loan, etc.), or may have established payment accounts with multiple payment systems. The accounts which are available to the guide for immediate payment requests may be entered in this field. The entry field may be implemented as a drop-down menu, and accounts may be displayed using various methods, such as account number, or a description of the account.

The payment amount/type field(s) 426 allows a guide to optionally specify the amount and/or type of an immediate payment request. Using this mechanism, a guide may choose to transfer amounts other than and including the total account balance if a defined condition is met. For example, if completion of a task results in a credit to the guide's search system account of $400 when it is completed, the guide may elect to transfer $200 to a savings account, and $150 to a checking account. Likewise a guide may elect to be compensated immediately when a goods and/or service goal is achieved.

The “add” button 428 allows a guide to add a new payment request to the list of automatic payment requests. The “delete” button 430 allows the guide to delete an existing payment request, for example by selecting the request from the list and activating the delete button 430. The “accept” button 432 allows the guide to accept the current list of automatic requests and save any modifications in the search database 124 (FIG. 1). The “cancel” button 434 (FIG. 5B) allows the guide to exit the GUI 420 without saving any modifications to the search database 124 (FIG. 1). The navigation controls 436 (FIG. 5B) allow a guide to navigate through the list of automatic payment requests.

The search system 114 (FIG. 1) may inform a searcher if an automatic request has been made. Various notification means, such as Instant Messaging, SMS, e-mail or other communication methods may be used. The payment system may confirm a transaction by conventional means.

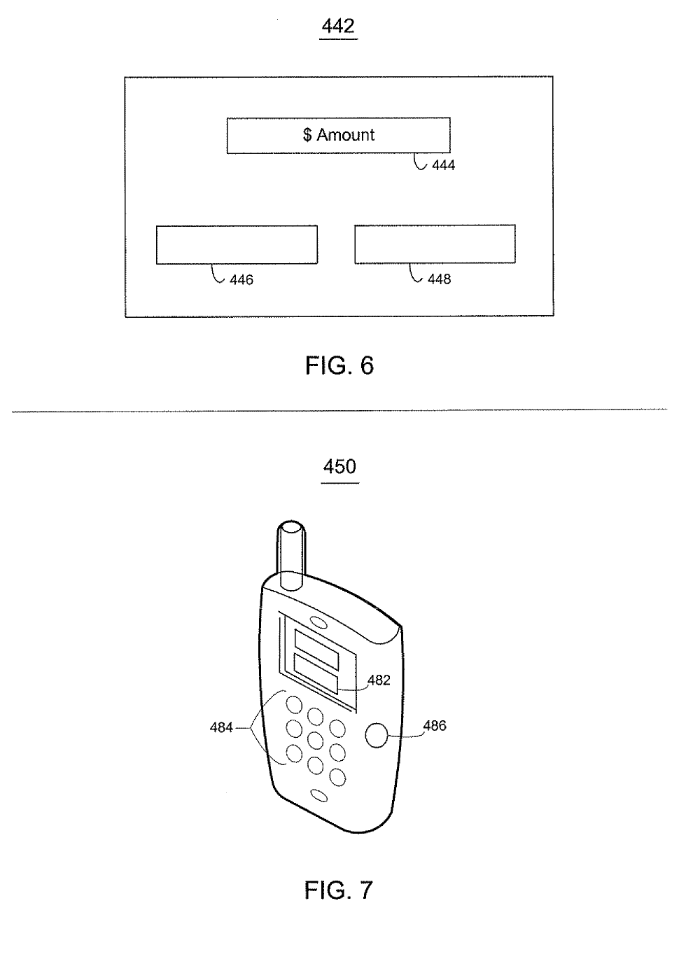

FIG. 6 depicts GUI 442 that can be displayed on computer system 120 if, for example, the button 402 (FIG. 5) is activated in at least one embodiment. The GUI 442 (FIG. 6) can include a field 444 that displays the amount in a searcher's account and which can be changed by the searcher by selecting the field and using computer number keys to specify a payment of not more than the total amount in the account. Of course, a searcher need not change the amount in field 444. A button or control 446 for activating a request for immediate payment can also be included. Optionally, the interface 442 can also include a button 448 to set the configuration preference to pay immediately when each task is completed, in which case a searcher would typically not be queried regarding editing the amount of payment.

The GUI or other capability of a cellular telephone, a PDA or other searcher device such as, the searcher device 140 (FIG. 1), may be limited and thus preferably simplified as compared to that for the computer system 120. In at least one embodiment, illustrated in FIG. 7, a GUI 450 of a searcher device, such as the searcher device 140 (FIG. 1), can include a field 482 (FIG. 7) in which the amount in a searcher's account is displayed. A searcher 118 (FIG. 1) can change the amount in the field 482 (FIG. 7) using the device keys 484 and can transmit the immediate payment request using a transmit/send button 486. As an alternative, two fields may be provided: a first in which the amount earned (or available) is shown as in search database 124 (FIG. 1) and a second in which a searcher can enter the amount to be transferred.

In the case where a searcher device has limited display and or interface capabilities, an appropriate interface many be provided. For example, when the searcher device has only voice input and audio output capability, a voice xML or a person may process an immediate payment request.

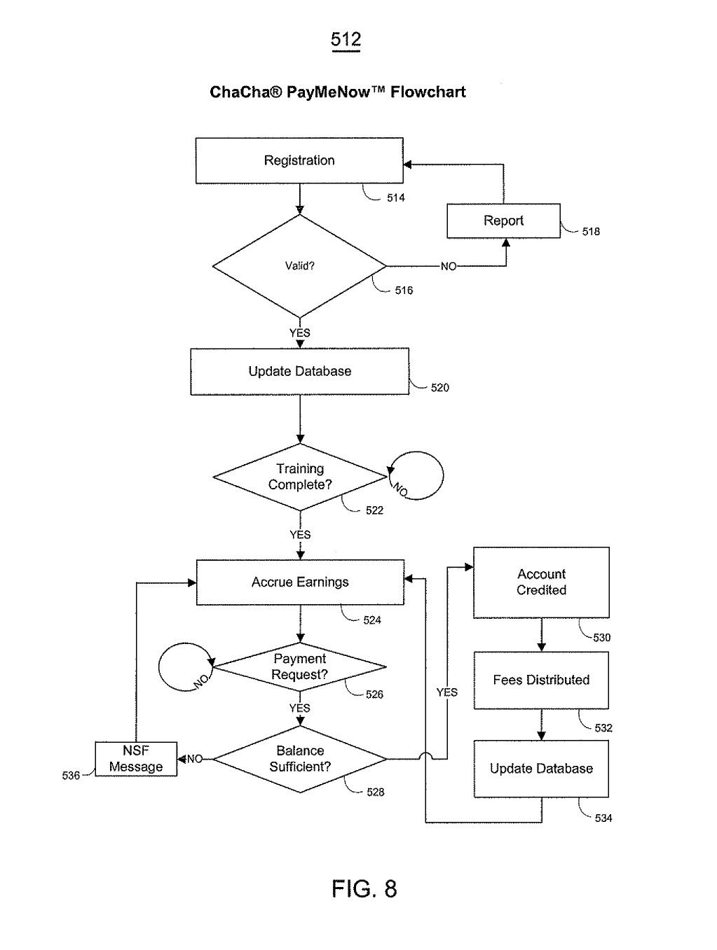

FIG. 8 depicts a series of operations 512 where a person or entity signs-up as a searcher or guide or provider, performs work, or receives compensation and gets substantially immediately paid. A person/entity first completes 514 registration. A validation of registration information is performed 516. If the validation is not successful, the system 114 (FIG. 1) issues a report 518 (FIG. 8) and returns to the registration operation 514 (FIG. 8). If the information is validated, registration data such as W9, taxpayer ID, etc. are stored by a database update 520. A guide/registrant is then trained 522. If training is not complete, process 512 continues to wait for training to be complete 522. If training is complete, the guide can enter service and begin to perform search tasks or search related tasks for which the guide account (see FIG. 4) would be credited 524 with earnings. A guide can then request 526 payment. If a guide does not request 526 payment, process 512 continues to wait for a request. The system checks 528 to see whether an account balance is sufficient. If not, an insufficient balance message is sent 536. The process 512 then returns to credit 524 a guide with earnings. If an account balance is sufficient, the search system 114 (FIG. 1) obtains payment data and performs a call to a payment system API (application programming interface) to send a transfer transaction for the payment amount to the payment system 128. At the payment system 128, the searcher (or guide) account 128b can be credited 530 (FIG. 8) (less transaction/handling fees), thereby paying the guide. The handling fees are then distributed 532. The search system 114 (FIG. 1) updates 534 (FIG. 8) the search database 124 (FIG. 1). Process 512 then returns to wait for a guide to accure earnings 524.

When another type of payment system is used, such as a bank, a searcher(s) may have individual bank accounts that would have associated debit/credit cards. The search system 114 has a company master account in the bank that is funded via revenue sources, such as advertising. The master account can be used to make real-time transfers to individual searcher accounts on a typical payment schedule (e.g., every two weeks), when the PayMeNow™ button is used, and/or when a searcher has specified that automatic and/or continuous payments should be made to his or her account. Any of the above may involve fees from the search system 114, from a bank, or from communication providers.

The discussion above indicates that a searcher can select to be paid continuously or when requested. If all the searchers have accounts in the payment system, the default payment method could be set to pay immediately always and the searchers/workers could select to be paid less frequently, such as upon request or by monthly paycheck. The payment could be based on other factors, such as a fixed threshold or when the searcher account balance relative to the handling fees reaches a percentage, etc as described in relation to FIG. 5B.

FIG. 9 depicts an exemplary GUI 550 for entry of payment account information by a guide or registered entity. The GUI 550 may be presented to a guide as part of the registration process 514 (see FIG. 8) and/or as requested by a guide. The GUI 550 may include name, address, phone number boxes 552, routing number box 554, account number box 556, description box 558, “accept” button 560 and/or “cancel” button 562.

Name, address, phone number boxes 552 (FIG. 9) may be used to enter account data regarding the searcher's account with the payment system. In at least one embodiment, this data may be automatically filled using information from the search database 124.

The routing number box 554 (FIG. 9) may be used to enter a routing number for a searcher's account in the payment system. The account number box 556 (FIG. 9) may be used to enter an account number for a searcher's account in the payment system. The description box 558 (FIG. 9) may be used to enter a descriptive title for the account.

The accept button 560 may be used to store the modified data in the search database 124 (FIG. 1). The cancel button 562 may be used to exit the GUI 550 without storing the modifications to the search database 124 (FIG. 1).

Any payment system account which may be used for immediate payment must be established with a payment system which meets the requirements described above. Although the system has been described using a single payment system it is envisioned that multiple payment systems may also be used.

It is also possible for the system to allow a searcher to have access to the earned money in the search database 124 whenever the searcher uses a debit/credit card account of the payment system 126. In such a system, the payment system 126, might receive a transaction, such as a request for authorization for the disbursal of funds from an ATM. If sufficient funds are not available in a searcher payment system account 128b, the payment system could query the search system 114 (i.e., generate an immediate payment request) seeking a funds transfer sufficient to cover the transaction, a form of over-draft protection. If sufficient funds are not available in the combined systems 114 and 126, the payment system 126, through the ATM, could issue an insufficient funds message to the searcher.

The system discussed herein may also allow a searcher to log into the system from any device and obtain GUIs or other interfaces that allow a payment request to be made, thus allowing the searcher to request payment from essentially any location.

Other types of electronic tasks or activities, such as processing bank back office international trade transaction activity, can also be handled as an activity like the search discussed above in which immediate payment can be made by the system discussed herein allowing immediate payment for such electronic tasks.

Although the system has been described with a searcher being able to request immediate “micropayment” payment as desired or when a task(s) is completed, the system can be set to always pay immediately after one or more tasks are completed, thus essentially always paying immediately or allowing a searcher to have access to earned funds.

The system may be configured to pay taxes, benefits, fees, etc., on an automatically calculated basis as is accomplished by services such as those provided by Paychex® of Rochester, N.Y.

The system has also been described with the payment system 126 being separate from the search system 114 furthermore the two systems can be combined into a single system.

Although the discussion herein indicates that the databases have records, the databases may store any data in any manner that allows access to the relevant information using appropriate access identification information.

A guide, searcher, entity or worker can also request that an immediate payment be made to another account, such as a credit card account or savings account to which the guide may want to make payments or transfer funds.

A searcher account in the search system may receive earnings for various reasons, such as credit for searches performed by others recruited by the searcher, as in a sponsoring system where a searcher signs-up other searchers to perform search work.

The work being paid for substantially immediately as discussed herein need not be electronic based work as long as the completion or an end point of the work or activity and the amount to be paid for the work can be entered into an electronic system. A work can be paid for in stages rather than at the end of completion of the work, such as at the end of each event in a series of events that comprise the work

Rather than withdraw funds via a debit card, a user could have the funds electronically transferred to other accounts within the bank or to other financial or non-financial institutions.

The search system itself could be part of a financial institution and thus the searcher account in the system would be a bank account.

The embodiments have been described with respect to a search system, but they could be practiced in other environments where independent contractors (guides or workers) perform work for which an on demand payment system is desirable.

The system could be part of a not-for-profit network in which the registrants are donees who are (for example) certified as being victims of a natural disaster. Such a system could provide immediate relief through existing infrastructure in a highly structured, and accountable, but rapidly deployable and flexible system. The system operator could be an existing charitable organization (UNICEF, American Red Cross, The Salvation Army, United Way, etc.) that has marketing expertise and a network of donors who could be organized as both donors and service providers to the network.

Likewise, a for-profit corporation such as a major retailer (e.g., The Home Depot®) might provide such a system in order to organize independent service providers who provide supplemental services (e.g., installation of products purchased) on a task-type basis. A contractor(s) might choose to be paid immediately in order to improve their cash-flow, and/or might also choose merchandise compensation as described above to allow them to improve buying power and/or influence the supplier base.

It also possible to organize the system in such a way that an affiliate(s) or sponsoree(s) of a guide/searcher/worker/entity is notified to allow a group of workers to reach an objective and receive payment substantially immediately. The earning power of group of registrants may be greater than the power of that same group as individuals, since at least one member can earn compensation for his or her tasks, and commission from his or her sponsoree(s).

Because the system may employ workers who may share common interests, the power of an affiliated merchant network could be used to obtain discounts using (for example) an electronic card.

As discussed above, a worker may be paid electronically using a card, but he or she might also use the network to buy merchandise outside of that offered by the search system provider, such as movie tickets, or prepay for merchandise and/or services which are offered by system affiliates. An instant payment system is implemented without a portable medium such as a debit card.

The system could also allow aggregation of earnings to a single account. For example, a single guide might not be able to earn enough to meet a condition in a given time period, but a group of searchers could decide to “donate” some or all of its earnings to a searcher account. Earnings could be applied/transferred/donated for a special need from a non-profit organization.

The system has been described with respect to a worker performing an activity and getting paid substantially immediately. It is also possible to the allow a worker to allocate earnings to a collective activity, such as disaster relief, as described in the related application entitled, “Method, System And Computer Program For Multilevel Marketing”, previously discussed. An organization/entity might have an account with the search system 114 which could accumulate earnings (e.g., small contributions from many searchers) which could then be paid substantially immediately to various accounts designated by the organization if a set of conditions are met.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A task based payment method, comprising:
performing, by a search related activity specialist, a search related activity; and
effecting substantially an immediate electronic payment to the specialist upon the completion of the activity.

2. A search based payment method, comprising:
performing search systems activity by a searcher for a user requesting the search; and
effecting substantially an immediate electronic payment to the searcher upon the completion of the search.

3. A method, comprising:
determining that an electronic search related task has been performed; and
effecting substantially immediate payment for the electronic work task.

4. A search related activity payment method, comprising:
performing a search related activity by a worker; and
effecting substantially an immediate electronic payment to the worker upon request in association with the activity.

5. A method as recited in claim 4, wherein the activity comprises one of an information search by a searcher for a user where search results are sent to the user and training a searcher.

6. A method as recited in claim 4, wherein the payment comprises one of cash compensation and non-cash compensation.

7. A method as recited in claim 6, wherein the non-cash compensation comprises one of merchandise, services, a gift certificate, points with an affiliated merchant and credit with an affiliated merchant.

8. A method as recited in claim 4, wherein the effecting comprises transferring a payment amount from a search system account to a searcher account.

9. A method as recited in claim 8, wherein the transferring comprises sending a payment amount transfer request to a payment system.

10. A method as recited in claim 9, wherein the payment system comprises a bank.

11. A method as recited in claim 5, wherein the effecting comprises allowing the searcher to draw a payment amount using an electronic card.

12. A method as recited in claim 5, wherein the effecting comprises determining whether a searcher account includes sufficient funds for a requested payment amount.

13. A method as recited in claim 5, wherein the effecting comprises:
presenting the searcher with a graphical user interface (GUI) showing an amount in a searcher search system account; and
allowing the searcher to specify a payment amount using the GUI.

14. A method as recited in claim 13, wherein the searcher can specify a payment trigger.

15. A method as recited in claim 5, wherein the effecting comprises allowing the searcher to request payment electronically.

16. A method as recited in claim 5, wherein performing comprises crediting a searcher search system account with income for the search.

17. A method as recited in claim 5, wherein the payment is triggered when a goal is met.

18. A search based payment method, comprising:
performing an information search by a searcher for a user requesting the search and sending search results to the user; and
effecting a substantially immediate electronic payment to the searcher after the sending of the search results upon request by the searcher comprising transferring a payment amount from a search system account to a searcher account in a financial institution.

19. A search based payment method, comprising:
performing an information search by a searcher for a user requesting the search and sending search results to the user; and
effecting a substantially immediate electronic payment to the searcher after the sending of the search results upon request by the searcher by allowing the searcher to make a purchase with a debit card.

20. A method, comprising:
crediting a searcher with earned income for a search in a search system searcher account;
providing the searcher with an interface for a payment request;
allowing the searcher to specify a payment using the interface;
presenting an advertisement to the searcher;
determining that the searcher has requested the payment from the searcher account;
identifying whether the searcher account has sufficient funds for the payment;
debiting the searcher account for the payment;
sending a credit account request to a payment system to credit a searcher payment account for the payment;
crediting the searcher payment account in the payment system for the payment and debiting a search system account for the payment;
confirming the transfer to the searcher; and
allowing the searcher to substantially immediately access funds in the payment account.

21. A method as recited in claim 20, wherein the determining, identifying, debiting, sending and crediting comprises no more than one minute.

22. A system, comprising:
a search system allowing a user to perform a search based on a user request and earn income for the search;
a payment system allowing the searcher to request and be substantially immediately paid the earned income.

23. A graphical user interface, comprising:
a field for a user to set a payment amount; and
a control allowing a user to initiate a request for substantially immediate payment of the payment amount.

24. A graphical user interface, comprising:
a field showing an earned income; and
a control allowing a user to initiate a request for substantially immediate payment of the earned income.

25. An interface as recited in claim 24, further comprising
a field for showing a search query to be searched by a guide; and
a search results field for showing search results for the query.

26. A computer readable storage for controlling a computer comprising a database, the database comprising:
a worker identifier field;
a payment system account identifier field for identifying a worker payment system account; and
an account balance field for holding an earned income balance earned by the worker in a system in which the worker works.

27. A task based payment method, comprising:
performing, by a worker, a task suitable for electronic based payment; and
effecting substantially an immediate electronic payment to the worker upon the completion of the task.

28. A graphical user interface, comprising:
a field specifying an account; and
a field specifying an immediate payment type.

29. An interface as recited in claim 28, wherein immediate payment types comprise at task completion, upon request and periodically.
